(19) United States
(12) Patent Application Publication
(10) Pub. No.: US 2018/0357667 A1
(43) Pub. Date: Dec. 13, 2018

(54) Systems and Methods for Interactive Media Communication

(71) Applicants: David R. Hall, Provo, UT (US); Peter Van Dyke, Salt Lake City, UT (US); David J. Kelley, Kent, WA (US); Joe Fox, Spanish Fork, UT (US)

(72) Inventors: David R. Hall, Provo, UT (US); Peter Van Dyke, Salt Lake City, UT (US); David J. Kelley, Kent, WA (US); Joe Fox, Spanish Fork, UT (US)

(21) Appl. No.: 15/616,084

(22) Filed: Jun. 7, 2017

(51) Int. Cl. G06Q 30/02; G06F 17/30; G06F 3/0482; H04L 29/08; G06K 9/00

(52) U.S. Cl. CPC G06Q 30/0251; G06F 17/30867; G06F 21/10; H04L 67/22; G06K 9/00288; G06F 3/0482

(57) ABSTRACT

A system and method is used to create, adapt, and deliver highly customized and targeted communications to a wide variety of people, with communication content being determined and adapted in real time. Communication content is determined by a wide variety of data captured during each encounter a person may have with the system. Captured data includes information sufficient to identify a person based on facial recognition and other biometric data as well as clothing, gait, etc. Each interactive media communication system will also capture encounter-specific data to associate with each person and encounter such as dwell time in general, dwell time as a function of displayed media, environmental conditions, time of day, presence of other people, location of encounter, etc. The data can be stored, aggregated, and parsed for use in creating customized communications for future encounters with each person.

### BACKGROUND OF THE INVENTION

### 1. Field of the Invention

The present invention relates generally to the field of communication and more specifically relates to systems and methods for interactive media communications using real-time feedback.

### 2. Related Art

Numerous types of devices are available to deliver media content. People will consumer media via their television, radio, computer, tablet, mobile phone, etc. Another popular content delivery option is visual displays such as billboards and point-of-sale displays, where various types of adverting messages may be displayed. Depending on the device and the communication channel, there are certain content customization options available to the content distributer.

For example, on the Internet, “cookies” may be used to remember certain characteristics related to a web browsing session, thereby providing an opportunity to deliver customized content via the web browser. For television, certain programs may lend themselves more readily to specific types of communications. This is demonstrated by the significant number of food products being advertised on cooking shows and home improvement products being advertised during shows that demonstrate do-it-yourself tips and techniques.

However, even though all of these customization options are available, there is no guarantee that the content is being delivered to the desired audience. The content distributor never knows who is watching the television or listening to the radio when their content is broadcast. Similarly, with account sharing options, virtual private networks and other obfuscation techniques, a web browser can't readily identify the actual person consuming the content being delivered via the Internet. Even with electronic billboard and point-of-sale displays, the content distributor doesn't know the identify of the content consumers that may encounter the content being displayed.

Given this, those skilled in the art are always looking for additional opportunities to provide media content that is customized for the audience of media consumers. However, the current media content distribution systems are largely built on large-scale assumptions of mass audiences. Accordingly, without creating additional opportunities to identify and segment much more granular audiences, customized media content delivery will continue to be sub-optimal.

### SUMMARY OF THE INVENTION

The present invention provides for a uniquely powerful system and method for creating and delivering highly customized and targeted communications to a wide variety of people, based on specific data associated with each person and their environment.

In at least one preferred embodiment of the present invention, a network of interactive media communication systems can monitor one or more persons, create, customize, and display interactive media content that can be adapted for specific situations, advertising campaigns, etc. Each interactive media communication system is configured to capture a wide variety of data associated with each encounter a person may have with the interactive media communication system, capturing data specific data on each person and each interaction. The data includes information sufficient to identify a person based on facial recognition and other biometric data as well as clothing, gait, etc.

The most preferred embodiments of the present invention will also capture encounter-specific data such as dwell time in general, dwell time as a function of displayed media, environmental conditions, time of day, presence of other people, location of encounter, etc. The data for each person and for each encounter for each person can be stored for later retrieval, analysis, and use in creating customized communications for future encounters with each person.

### BRIEF DESCRIPTION OF THE SEVERAL VIEWS OF THE DRAWINGS

The preferred embodiments of the present invention will hereinafter be described in conjunction with the appended drawings, wherein like designations denote like elements, and

FIG. 1 is a block diagram for an interactive media communication system in accordance with a preferred exemplary embodiment of the present invention;

FIG. 2 is a block diagram for a computer hardware/software combination for an interactive media communication system in accordance with a preferred exemplary embodiment of the present invention;

FIG. 3 is a block diagram of a memory for an interactive media communication system in accordance with a preferred embodiment of the present invention;

FIG. 4 is a block diagram of a network of connected interactive media communication systems in accordance with a preferred embodiment of the present invention; and

FIG. 5 is a flow chart of a method for an interactive media communication system in accordance with a preferred exemplary embodiment of the present invention.

### DETAILED DESCRIPTION OF THE INVENTION

A system and method is used to create, adapt, and deliver highly customized and targeted communications to a wide variety of people, with communication content being determined and adapted in real time. Communication content is determined by a wide variety of data captured during each encounter a person may have with the system. Captured data includes information sufficient to identify a person based on facial recognition and other biometric data as well as clothing, gait, etc.

Each interactive media communication system will also capture encounter-specific data to associate with each person and encounter such as dwell time in general, dwell time as a function of displayed media, environmental conditions, time of day, presence of other people, location of encounter, etc. The data can be stored, aggregated, and parsed for use in creating customized communications for future encounters with each person.

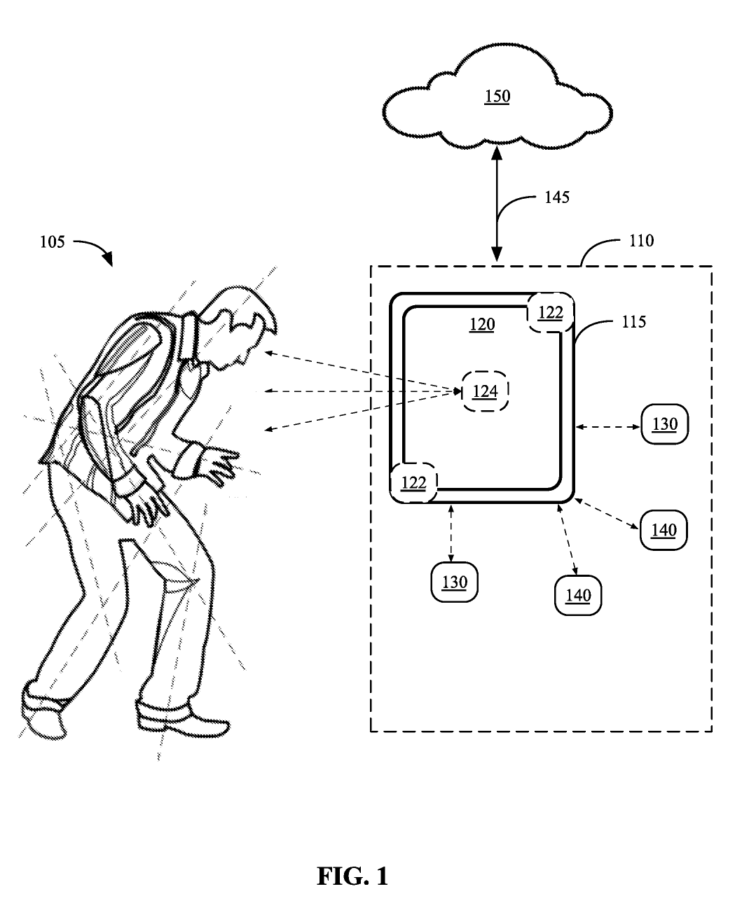

Referring now to FIG. 1, a block diagram for an interactive media communication system 110 in accordance with a preferred exemplary embodiment of the present invention is depicted. As shown in FIG. 1, one or more persons 105 is positioned to interact with interactive media communication system 110.

In the most preferred embodiments of the present invention, interactive media communication system 110 comprises a housing 115, with housing 115 housing a display 120; one or more image capture devices 124; and one or more optional embedded sensor 122. In addition, one or more environmental sensors 130 and one or more supplemental sensors 140 may be included as part of interactive media communication system 110.

Display 120 may be any kind of screen suitable for displaying electronically generated images. Depending on the specific application environment, it may be opaque, a “one-way” mirror, or semi-transparent, allowing image capture device 124 to be placed behind screen 120 and yet capture images of people and objects placed in front of it. Alternatively, image capture device 124 may be contained in a bezel or other decorative edge surrounding or encircling screen 120. In at least one preferred embodiment of the present invention, screen 120 is a touch screen and may receive input from person 105 whenever person 105 touches or presses on the surface of screen 120.

Image capture device 124 comprises any type of image capture device that is suitable for capturing a plurality of images of person 105, including facial expressions, arm and leg movement and overall body movement. Image capture device 124 is selected for the specific application and may include multiple cameras as well as a single image capture device. For example, in a low light environment, image capture device 124 may comprise an image capture device that is configured to capture infrared images and video of person 105. Additionally, each image capture device 124 may be configured to track and capture eye movement, thereby storing information related to which portions of display 120 were viewed at what time and for how long by person 105. Those skilled in the art will appreciate that any image capture device known or developed in the future may be selected, so long as it is capable of capturing images appropriate for the application.

Optional embedded sensors 122 comprise at least one sensor that is configured to detect, capture, and report one or more data elements that are useful for the application environment where interactive media system 110 is deployed. Embedded sensors 122 may comprise one or more environmental sensors 130 and/or one or more supplemental sensors 140.

Optional environmental sensors 130 comprise at least one optional sensor that is capable of detecting, capturing, and reporting ambient environmental conditions. For example, ambient noise level, ambient light level, ambient temperature level, and ambient humidity level. In addition, each environmental sensor 130 will be communicatively coupled with interactive media communication system 110 to enable each environmental sensor 130 to transmit data to interactive media communication system 110. Those skilled in the art will recognize that the communication may be implemented via wireless or wired communication media. For example, Bluetooth, Wi-Fi, near-field communication (“NFC”), high-speed Ethernet cable or other communication media may be used to communicatively couple environmental sensors 130 to interactive media communication system 110.

Optional supplemental sensor 140 comprise at least one optional device that is capable of capturing additional data, other than the environmental data collected by environmental sensors 130. Examples of supplemental sensor 140 would include still photo and video cameras, audio recording devices, etc. In addition, each supplemental sensor 140 will communicatively coupled with interactive media communication system 110 to enable each supplemental sensor 140 to transmit data to interactive media communication system 110. Those skilled in the art will recognize that the communication may be implemented via wireless or wired communication media. For example, Bluetooth, Wi-Fi, near-field communication (“NFC”), high-speed Ethernet cable or other communication media may be used to communicatively couple supplemental sensor 140 to interactive media communication system 110.

Image capture device 124 comprises one or more image capture devices that is suitable for capturing a plurality of images (still and motion images) of person 105 and the surrounding environment, including hand and leg movement, facial expressions, and overall body movement associated with person 105. Image capture device 124 is selected and configured based on the specific application and location and may include multiple cameras as well as a single camera.

For example, in a low light environment, image capture device 124 may comprise an image capture device that is configured to capture one or more infrared images of person 105. One particularly relevant feature of image capture device 124 is the ability to capture enough details to perform facial recognition. Additionally, as shown in FIG. 1, by capturing and extrapolating limb positions and joint locations (represented by the dashed lines in FIG. 1) additional information such as posture and body language may be observed or calculated. Those skilled in the art will appreciate that any image capture device known or developed in the future may be selected, so long as it is capable of capturing images appropriate for the desired application.

Communication connection 145 represents any type of wired and/or wireless communication connection to a network such as “cloud” 150 (e.g. where cloud 150 represents a computer network such an intranet, wide area network, or the Internet) whereby data captured by interactive media communication system 110, including audio and video data and other information from the various sensors, may be transmitted to one or more geographically remote locations. System operations data, including runtime, interaction statistics, and other performance data may also be transmitted to a geographically remote location via communication connection 145.

Those skilled in the art will recognize that image capture device 124, supplemental sensors 140, environmental sensors 130, and embedded sensors 122 may be provided in any number and provided in various packaged configurations based on the specific application. For example, image capture device 124 and all related sensors may be contained in a single housing and positioned behind display 120. No specific numbers or type of sensors are required and there is no limit to the number of sensors that may be included.

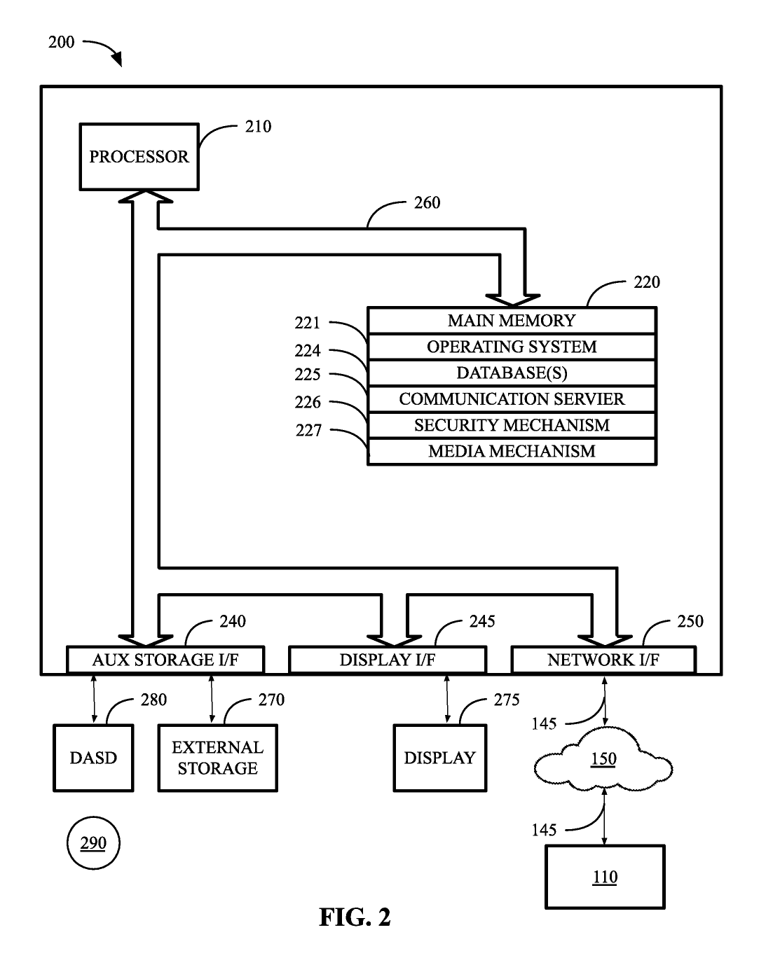

Referring now to FIG. 2, a block diagram for a computer hardware/software device (e.g. computer or server) 200 for implementing and deploying an interactive media system in accordance with a preferred exemplary embodiment of the present invention is depicted. As shown in FIG. 2, server 200 represents one of many commercially available computer systems such as IBM/Intel based systems such as a Linux®-based computer system, or Microsoft Windows® compatible computer system, or a Macintosh® computer system. However, those skilled in the art will appreciate that the methods and system of the present invention apply equally to any computer system, regardless of the specific operating system and regardless of whether the computer system is a traditional hosted computer server, a “virtual server” (e.g., scalable servers provided by Amazon Web Services “AWS”), or a single user device such as a personal computer or workstation.

Server 200 suitably comprises at least one Central Processing Unit (CPU) or processor 210, an auxiliary storage interface 240, a display interface 245, and a network interface 250, all of which are interconnected via a system bus 260. Note that various modifications, additions, or deletions may be made to server 200 illustrated in FIG. 2 within the scope of the present invention such as the addition of cache memory or other peripheral devices. FIG. 2 is not intended to be exhaustive, but is presented to simply illustrate some of the more salient features of Server 200.

Auxiliary storage interface 240 allows server 200 to store and retrieve information from auxiliary storage devices, such as external storage mechanism 270, magnetic disk drives (e.g., hard disks) or solid state storage devices (e.g., flash memory drives etc.). One suitable storage device is a direct access storage device (“DASD”) 280. As shown in FIG. 2, DASD 280 may be a solid-state drive that may read programs and data from flash memory or SD disk 290.

Display interface 245 is used to directly connect one or more displays 275 to server 200. Note, however, that while display interface 245 is provided to support communication with one or more displays 275, computer server 200 does not necessarily require a display 275, because all needed interaction with users and other processes may occur via remote connections.

Network interface 250 is used to connect server 200 to communication connection 145, cloud 150, and interactive media communication system 110 of FIG. 1. Network interface 250 broadly represents any suitable way to communicatively couple electronic devices. Network interface 250 preferably includes a combination of hardware and software that allows communications to and from interactive media communication system 110 of FIG. 1. A database may reside remote from the housing, and the processor communicates with the database though a cloud based network.

It is important to note that while the present invention has been (and will continue to be) described in the context of a specific computer system with certain application software, those skilled in the art will appreciate that the various software mechanisms of the present invention are capable of being distributed as a program product in conjunction with an article of manufacture comprising software stored on a computer readable storage medium in a variety of forms, and that the various preferred embodiments of the present invention applies equally regardless of the particular type or storage medium used to actually carry out the distribution. Examples of computer readable storage media include: recordable type media such as Flash Drives and SD disks (e.g., disk 290), and transmission type media such as digital and analog communication links, including wireless communication links.

Main memory 220 suitably contains an operating system 221, one or more databases 224, a communication server 225, a security mechanism 226, and a media mechanism 227. The term “memory” as used herein refers to any storage location in the virtual memory space of server 200. The database may reside remote from the housing, and the processor communicates with the database though a cloud based network.

It should be understood that main memory 220 might not necessarily contain all parts of all components shown. For example, portions of operating system 221 may be loaded into an instruction cache (not shown) for processor 210 to execute. In addition, although database(s) 224 is shown to reside in the same memory location as operating system 221, those skilled in the art will appreciate that certain portions of main memory 220 may be stored in multiple locations, including a memory location physically associated with interactive media communication system 110 of FIG. 1. The exact location of all data or information will depend on application specific functionality such as requirements for speed of data delivery, data redundancy, etc. A database may reside remote from the housing, and the processor communicates with the database though a cloud based network.

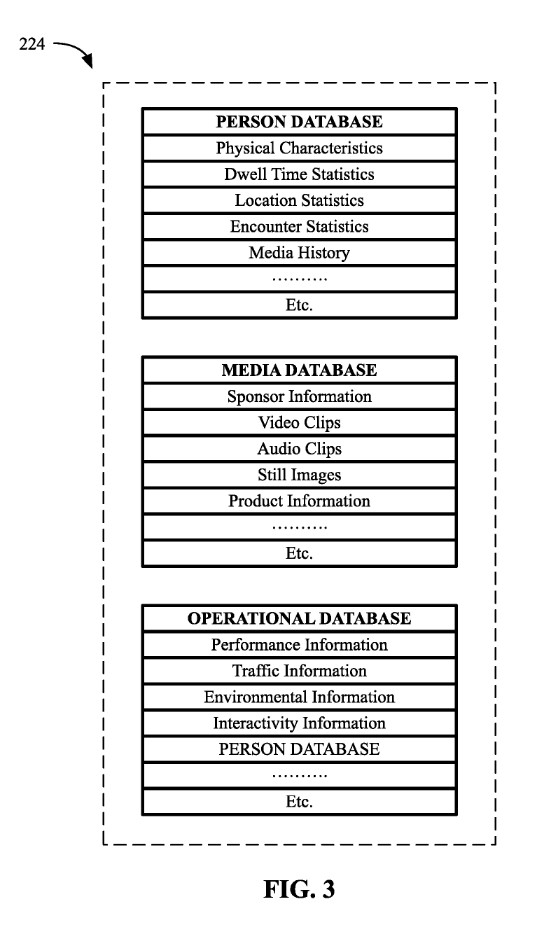

In the most preferred embodiments of the present invention, database 224 will comprise a plurality of information that may be useful in conjunction with a preferred embodiment of interactive media communication system 110 of FIG. 1. For example, database 224 will most preferably contain information about the identity and background of content creators as well as content consumers. Additional information about database 224 is set forth in FIG. 3. The database may reside remote from the housing, and the processor communicates with the database though a cloud based network.

In at least one preferred embodiment of the present invention, database 224 will typically include a plurality of database records containing information about each person 105 that has had an encounter with interactive media communication system 110 of FIG. 1 (captured facial recognition and other biometric data including height and weight, age, clothing, extrapolated or calculated mood and response data, etc.), information about each encounter (e.g., location of encounter, dates and times of encounter, length of time of encounter, etc.) as well as information about media content both available and delivered to person 105 (e.g., type and category of media content, when and where delivered, contact information for the content owner, etc.), as well as information providing for tracking, analyzing and reporting information that may be used to provide various content services to the operators and users of interactive media communication system 110 of FIG. 1.

Those skilled in the art will recognize that other types of information for other types of data that may be used in other applications (e.g., historical, informational, technical, etc.) may be stored and retrieved as well. While database 224 is shown to be residing in main memory 220, it should be noted that database 224 might also be physically stored in a location other than main memory 220. For example, database 224 may be stored on external storage device 270 or DASD 280 and coupled to server 200 via auxiliary storage I/F 240. Additionally, while shown as a single database 224, those skilled in the art will recognize the database 224 may actually comprise a series of related databases, logically linked together. Depending on the specific application and design parameters, database 224 may take many different forms when implemented.

The most preferred embodiments of interactive media communication system 110 of FIG. 1 will typically include a communication server 225 in main memory 220. Communication server 225 is an automated programmable system that is capable of generating one or more forms of messages or message events. For example, communication server 225 may be configured to send automated email messages or SMS messages to cell phones. Communication server 225 may also be used to generate a hard copy or paper-based document (e.g., mail merge letters) using a printer that are then sent via standard U.S. Postal Service or some type of commercial message delivery company. A database may reside remote from the housing, and the processor communicates with the database though a cloud based network.

Additionally, communication server 225 may be configured to generate a facsimile message by utilizing fax server and a facsimile modem (not shown this FIG.) that is contained in server 200 of FIG. 2. Communication server 225 is also capable of being configured and used to send and receive various electronic status messages (e.g. audio and video alerts) and updates to users and operators of server 200 and interactive media communication system 110 of FIG. 1, as may be necessary to enhance the overall process of completing activities related to the provision of adaptive media communications as described herein.

This includes the generation of automated email messages relating to the tracking and reporting of performance and events as well as sending informational messages related to system performance, communication messaging, etc. Automated or on-demand e-mail messages may also be generated to provide notifications regarding activities and events as well as other information for related to the communications and participants in accordance with the various preferred embodiments of the present invention.

In addition, most preferred embodiments of the present invention might include a security and/or encryption mechanism 226 for verifying access to the data and information contained in and transmitted to and from server 200. Security mechanism 226 may be incorporated into operating system 221. Additionally, security mechanism 226 may also provide encryption capabilities for other components of interactive media communication system 110 of FIG. 1, thereby enhancing the robustness of interactive media communication system 110 of FIG. 1. Security mechanism 226 is most preferably configured to protect the integrity and security of the information transmitted via cloud 150 of FIG. 1.

Further, depending on the type and quantity of information stored in database 224 and security mechanism 226 may provide different levels of security and/or encryption for the information stored in database 224. The level and type of security measures applied by security mechanism 226 may be determined by the identity of the end-user and/or the nature of a given request and/or response. In some preferred embodiments of the present invention, security mechanism 226 may be contained in or implemented in conjunction with certain hardware components (not shown this FIG.) such as hardware-based firewalls, switches, dongles, and the like.

Media mechanism 227 is a software mechanism that is configured to receive inputs from each sensor and, based on the inputs received as well as the data stored in database 224, generate and deliver customized media content from database 224 to person 105 of FIG. 1. The most preferred embodiments of the present invention include the generation and delivery of customized media content based on inputs to media mechanism 227 that are the result of demographic factors, biometric factors, environmental factors, facial recognition, etc. In this fashion, highly targeted media content can be selected from database 224 and delivered to person 105 for consumption.

For example, if interactive media communication system 110 determines that person 105 is a teenaged Hispanic female, and interactive media communication system 110 is located outside a shopping mall in a major metropolitan area, and there is a movie theater adjacent to the mall where a movie targeted at teenaged Hispanic females is being screened in the next 30-60 minutes, interactive media communication system 110 can display a movie trailer on screen 120 while also displaying show times for the movie. If the teenaged Hispanic female is engaged by the trailer, and image capture device 124 detects positive body language and facial expressions, a longer trailer may be displayed and a coupon for drinks and snacks at the movie theater may be dispensed.

Alternatively, a quick response (“QR”) code may be displayed on screen 120, allowing the teenaged Hispanic female to capture the QR on a mobile phone, thereby creating a discount coupon on the mobile phone that can be redeemed at the theater. A QR code is a machine-readable code consisting of an array of black and white squares, typically used for storing URLs or other information for reading by a camera on a smartphone or tablet.

In another example, if interactive media communication system 110 determines that person 105 is a young mother holding an infant or accompanied by a small child, and interactive media communication system 110 is located inside a hospital or other medical facility, interactive media communication system 110 can display a short Public Service Announcement (“PSA”) about childhood immunizations on screen 120. If the young mother is not engaged by the PSA, and image capture device 124 detects negative body language and facial expressions, media mechanism 227 of interactive media communication system 110 may use these inputs to quickly change the content delivered via screen 120 and offer content (e.g. patient waiting times for pediatricians in the medical facility) that may be of greater interest to the young mother.

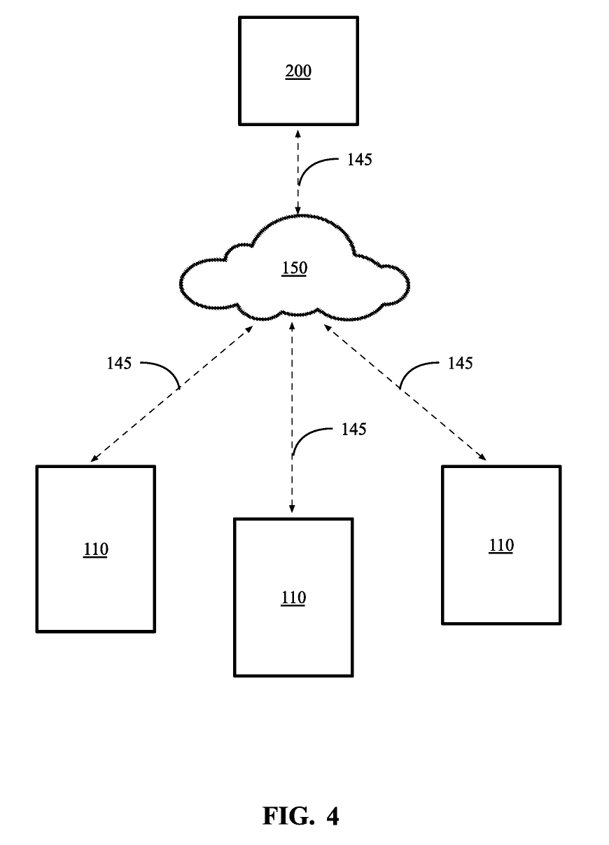

Referring now to FIG. 3, portions of database 224 of FIG. 4 are depicted. As shown in FIG. 3, the most preferred embodiments of the present invention will contain detailed information on each person who encounters interactive media communication systems 110 from FIG. 1. Similarly, media content and detailed information about the media content will also be contained in database 224. For example, each element of media content stored in database 224 will be “tagged” with one or more identifiers, or categorical markers, defining the types of people, locations, times, and other details that will be used to select and deliver customized content. Operational details regarding the performance and operation of interactive media communication systems 110 from FIG. 1 will also be captured and stored. Each encounter element, to the extent that it can be captured, calculated, or extrapolated, will be stored in database 224.

Referring now to FIG. 4, a network of interactive media communication systems 110 of FIG. 1 is depicted. As shown in FIG. 4, a plurality of interactive media communication systems 110 from FIG. 1 are communicatively coupled to server 200 from FIG. 2 via communication connection 145 and cloud 150.

Those skilled in the art will recognize that the connection of multiple interactive media communication systems 110 will provide additional opportunities for enhanced data sharing and more robust communication message delivery options. For example, a single person may interact with each of the plurality of interactive media communication systems 110 over a period of time, providing for a high level of customization for the communication and messaging interaction with the person. Information such as which locations and times of day a person encounters interactive media communication systems 110, as well as the responses to the media delivered or displayed to the person over a period of time can be captured. Dwell time (e.g., time spent interacting with interactive media communication systems 110, as well as time spent viewing or consuming media content from interactive media communication systems 110, will all provide valuable consumer information for media and content customization purposes.

Given that each interaction or encounter with an interactive media communication system 110 can be stored in database 224 of FIG. 2, the media content and other communications delivered to a person over time will be enhanced and refined by the number of interactions and encounters that have occurred in the past. This level of content customization is not available with any system known to exist at this time.

In at least one preferred embodiment of the present invention, a person's demographics, movements, and media preferences can be observed and highly customized media may be delivered to that person via multiple interactive media communication systems 110. In an advertising venue, clothing sizes and color/shape/style preferences may be stored and used to create and deliver highly customized and targeted media advertisements. In a medical environment, medical data regarding the person such as vital signs, changes in appearance, etc. may be collected and used to create preliminary medical treatment plans. In an academic environment, media content related to schooling options, class selection, available housing, etc. may be captured and used to create and recommend custom educational plans and living arrangements.

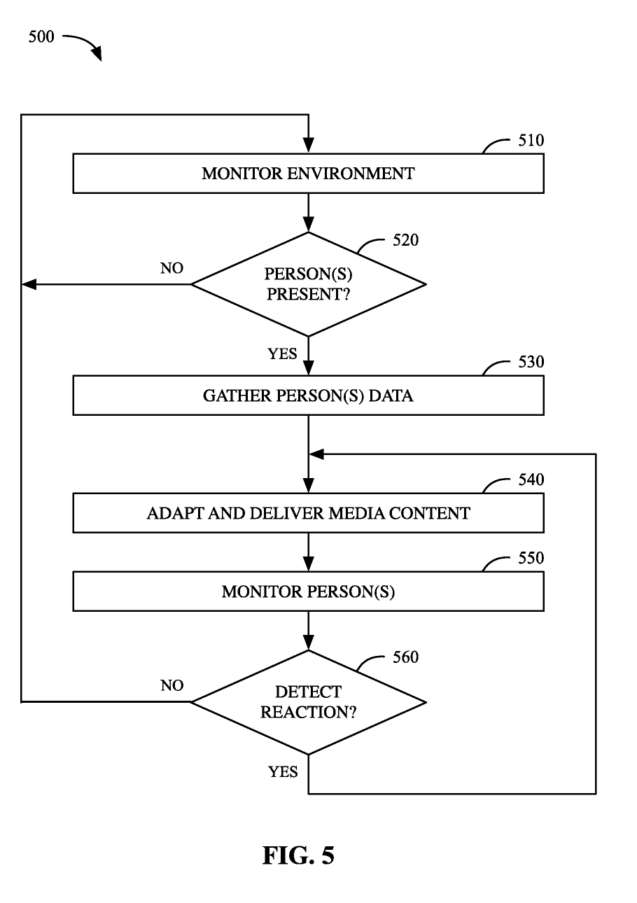

Referring now to FIG. 5, a flow chart of a method 500 for an interactive media communication system 110 in accordance with a preferred exemplary embodiment of the present invention is depicted. As shown in FIG. 5, an interactive media communication system 110 may be placed into an environment where it will begin monitoring the environment (step 510) until one or more persons enters the monitored environment (step 520=“YES”). As long as that event does not occur (step 520=“NO”), interactive media communication systems 110 will remain in monitoring mode.

After being activated by the presence of one or more persons, interactive media communication system 110 will use an image capture device and one or more sensors to collect data relative to the person and the environment (step 530). Based on the application, the information gathered in real time, and the stored data from at least one database, interactive media communication system 110 will begin to adapt and customize appropriate media content for consumption by the person or persons (step 540).

Interactive media communication system 110 will continue to monitor the person or persons (step 550) and try to detect any reaction (step 560). If a reaction is detected (step 560=“YES”), then interactive media communication system 110 will, based on the nature of the reaction, adapt and deliver additional media content for consumption by the person or persons (step 540=“YES”). If no reaction is detected or detectable (step 560=“NO”), after some period of time interactive media communication system 110 will once again return to the monitoring state (step 510). Those skilled in the art will recognize that method 500 provides for real-time selection of the most relevant media content, based on a continual review and iterative approach to media content selection, all based on the inputs received from an image capture device and one or more sensors.

In this manner, using the system and method for interactive media communication described herein, highly customizable and adaptable media content can be developed and delivered. Those skilled in the art will recognize that “media content” may take many forms and can be delivered via many different paths. For example, “media content” can be audio-video content displayed at a point-of-sale, it may be email content delivered to a person via computer, smart phone, or tablet. It may be a coupon that is automatically printed and made available at the interactive media communication system location. Those skilled in the art will recognize that the potential types and delivery systems for media content are practically endless.

From the foregoing description, it should be appreciated that the systems and methods for interactive media communication systems disclosed herein presents significant benefits that would be apparent to one skilled in the art. Furthermore, while multiple embodiments have been presented in the foregoing description, it should be appreciated that a vast number of variations in the embodiments exist.

Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. An interactive media communication system for delivering customized media content, the interactive media system comprising:
a housing;
a screen coupled to the housing;
at least one image capture device coupled to the housing, the at least one image capture device being configured to capture a plurality of images from an area surrounding the interactive media communication system;
at least one processor contained within the housing;
at least one sensor, the at least one sensor being communicatively coupled to the at least one processor and being further configured to capture a plurality of environmental data from the area surrounding the interactive media communication system;
a memory contained within the housing, the memory being communicatively coupled to the at least one processor;
a database, the database being communicatively coupled to the at least one processor, the database comprising a plurality of records containing media content and data about a plurality of persons, environments, and locations;
a media mechanism residing in the memory, the media mechanism being configured to iteratively select media content from the database based on a continuous review of the plurality of images and the plurality of environmental data and being further configured to communicate the media content to at least one person.

2. The interactive media communication system of claim 1 wherein the screen is semi-opaque and the at least one image capture device is positioned inside the housing and behind the screen.

3. The interactive media communication system of claim 1 wherein the database comprises a plurality of records for a plurality of individuals, wherein each record comprises a plurality of data for a plurality of previous encounters with the interactive media communication system.

4. The interactive media communication system of claim 1 wherein the screen is a touch screen and one or more additional inputs are transmitted to the media mechanism based on at least one contact on the touch screen.

5. The interactive media communication system of claim 1 wherein the media content is communicated to the at least one person by a message selected from the group of an email message, an audio message, a video message, and a QR code.

6. The interactive media communication system of claim 1 further comprising a security mechanism residing in the memory, the security mechanism being configured to control access to the media mechanism and the plurality of records containing media content and data about a plurality of persons, environments, and locations.

7. The interactive media communication system of claim wherein the at least one sensor comprises at least one embedded sensor, at least one environmental sensor, and at least one supplemental sensor.

8. The interactive media communication system of claim 1 wherein the at least one image capture device comprises at least one digital camera, the at least one digital camera being configured to capture still and moving images.

9. The interactive media communication system of claim 1 wherein the selection of media content is based at least in part on dwell time during an encounter of a person with the interactive media communication system.

10. The interactive media communication system of claim 1 wherein:
the at least one image capture device comprises at least one digital camera;
the at least one digital camera is configured to capture still and moving images;
the selection of media content is based at least in part on dwell time during an encounter of a person with the interactive media communication system;
the at least one sensor comprises at least one embedded sensor, at least one environmental sensor, and at least one supplemental sensor;
the media content is communicated to the at least one person by a message selected from the group of an email message, an audio message, a video message, and a QR code;
the screen is a touch screen and one or more additional inputs are transmitted to the media mechanism based on at least one contact on the touch screen; and
the database comprises a plurality of records for a plurality of individuals, wherein each record comprises a plurality of data for a plurality of previous encounters with the interactive media communication system.

11. A method for interactive media communication, the method comprising the steps of:
deploying an interactive media communication system in an environment;
using the interactive media communication system to monitor the environment to detect the presence of at least one person;
when at least one person is detected by the interactive media communication system, gathering data regarding the at least one person;
adapt and deliver preliminary media content to the at least one person based on the data gathered regarding the at least one person;
monitoring the at least one person;
adapting and delivering additional media content based on a reaction to the preliminary media content;
continuing to adapt and deliver additional media content for as long as the at least one person is present at the interactive media communication system and continues to provide a reaction to the additional media content.

12. The method of claim 11 wherein the interactive media communication system comprises:
a housing;
a screen coupled to the housing;
at least one image capture device coupled to the housing, the at least one image capture device being configured to capture a plurality of images from an area surrounding the interactive media communication system;
at least one processor contained within the housing;
at least one sensor, the at least one sensor being communicatively coupled to the at least one processor and being further configured to capture a plurality of environmental data from the area surrounding the interactive media communication system;
a memory contained within the housing, the memory being communicatively coupled to the at least one processor;
a database residing in the memory, the database being communicatively coupled to the at least one processor, the database comprising a plurality of records containing media content and data about a plurality of persons, environments, and locations;
a media mechanism residing in the memory, the media mechanism being configured to iteratively select media content from the database based on a continuous review of the plurality of images and the plurality of environmental data and being further configured to communicate the media content to at least one person.

13. The method of claim 12 wherein the database comprises a plurality of records for a plurality of individuals, wherein each record comprises a plurality of data for a plurality of previous encounters with the interactive media communication system.

14. The method of claim 12 wherein the screen is a touch screen and one or more additional inputs are transmitted to the media mechanism based on at least one contact on the touch screen.

15. The method of claim 12 wherein the media content is communicated to the at least one person by a message selected from the group of an email message, an audio message, a video message, and a QR code.

16. The method of claim 12 wherein the at least one image capture device comprises at least one digital camera, the at least one digital camera being configured to capture still and moving images.

17. The method of claim 12 wherein the selection of media content is based at least in part on dwell time during an encounter of the at least one person with the interactive media communication system.

18. The method of claim 12 further comprising a security mechanism residing in the memory, the security mechanism being configured to control access to the media mechanism and the plurality of records containing media content and data about a plurality of persons, environments, and locations.

19. The method of claim 12 wherein:
the at least one image capture device comprises at least one digital camera;
the at least one digital camera is configured to capture still and moving images;
the selection of media content is based at least in part on dwell time during an encounter of a person with the interactive media communication system;
the at least one sensor comprises at least one embedded sensor, at least one environmental sensor, and at least one supplemental sensor;
the media content is communicated to the at least one person by a message selected from the group of an email message, an audio message, a video message, and a QR code;
the screen is a touch screen and one or more additional inputs are transmitted to the media mechanism based on at least one contact on the touch screen; and
the database comprises a plurality of records for a plurality of individuals, wherein each record comprises a plurality of data for a plurality of previous encounters with the interactive media communication system.

20. The interactive media communication system of claim 1, wherein the database resides remote from the housing, and the processor communicates with the database though a cloud based network.
